(19) United States
(12) Patent Application Publication
(10) Pub. No.: US 2026/0105315 A1
(43) Pub. Date: Apr. 16, 2026

(54) Preference Optimization For Large Language Model Training

(71) Applicant: Zoom Communications, Inc., San Jose, CA (US)

(72) Inventors: Tao Meng, Jersey City, NJ (US); Shujian Zhang, Sunnyvale, CA (US); Lingxiao Zhao, Pittsburgh, PA (US); Wenxuan Zhou, Los Angeles, CA (US)

(21) Appl. No.: 19/356,863

(22) Filed: Oct. 13, 2025

Related U.S. Application Data
(60) Provisional application No. 63/707,130, filed on Oct. 14, 2024.

(51) Int. Cl. G06N 3/092

(52) U.S. Cl. CPC G06N 3/092

(57) ABSTRACT

An artificial intelligence (AI) training system may perform, based on a preference dataset, direct preference optimization (DPO) on a policy model corresponding to a large language model (LLM). The AI training system may determine a learned token-level reward based on the DPO and determine, using the LLM, a derived token-level reward. The AI training system may generate, based on the learned token-level reward and the derived token-level reward, an optimized policy model and provide the optimized policy model for use with a software service.

### CROSS REFERENCE TO RELATED APPLICATIONS

This application claims the benefit of U.S. Provisional Patent Application Ser. No. 63/707,130, filed Oct. 14, 2024, the entire disclosure of which is incorporated herein by reference.

### FIELD

This disclosure generally relates to an artificial intelligence (AI) system, and, more specifically, to preference optimization for large language model (LLM) training.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of an artificial intelligence (AI) system for processing user requests associated with software services of a software platform.

FIG. 5 is a block schematic diagram of an example of preference optimization with token-level regularization for large language model (LLM) training functionality of an AI system.

FIG. 6 is a flowchart of an example of a technique for preference optimization with token-level regularization.

### DETAILED DESCRIPTION

Enterprise entities rely upon several modes of communication to support their operations, including telephone, email, internal messaging, and the like. These separate modes of communication have historically been implemented by service providers whose services are not integrated with one another. The disconnect between these services, in at least some cases, requires information to be manually passed by users from one service to the next. Furthermore, some services, such as telephony services, are traditionally delivered via on-premises solutions, meaning that remote workers and those who are generally increasingly mobile may be unable to rely upon them. One solution is by way of a unified communications as a service (UCaaS) platform, which includes several software services corresponding to multiple communications modalities integrated over a network, such as the Internet, to deliver a complete communication experience regardless of physical location. The software services of a UCaaS platform may thus enable synchronous and asynchronous communications between users. In some cases, the software services of a UCaaS platform may implement other functionality as well, for example, for using digital whiteboards, making workspace reservations, or the like.

A software platform, such as a UCaaS platform, may provide artificial intelligence (AI) functionality for use with the software services thereof. Use of the AI functionality may enhance the user experience by automating processes, answering prompted questions with minimal or no disruption to an active communication session, or introducing capabilities previously unavailable to software service users. Such AI functionality may be implemented using one or more machine learning (ML) models, which may be trained to process specific types of input and produce specific types of output. For example, ML functionality enabled for use during a video conference may be implemented using a large language model (LLM) trained to obtain user requests as natural language prompts and to produce output responsive to the user requests in a same language as that which the prompts are obtained. In one non-limiting example, a video conference participant who joins the video conference after it began may submit a user request to an LLM to ask for a summary of the discussion that occurred during the video conference before the participant joined. The LLM may evaluate a real-time transcription of the video conference (e.g., produced using automated speech recognition or a like tool) to present output concisely summarizing that discussion.

LLMs are a type of AI designed to understand and generate human language by leveraging vast amounts of textual data. These models, often built using architectures like transformers, are trained to predict the next word or token in a sentence, allowing them to perform tasks such as translation, summarization, and text generation. The training process involves feeding the model massive datasets of text and adjusting internal parameters, such as weights and biases, to optimize predictions based on the input context. LLMs rely heavily on natural language processing (NLP) techniques to understand the syntax, semantics, and nuances of human language.

Tokens, in the context of LLMs, are the basic units of data that the model processes. A token can represent a word, subword, or even a single character, depending on the tokenization scheme being used. For example, a token might be the word “apple” or a subpart of it like “ap” and “ple,” depending on how the model has been trained to segment text. The tokenization process splits the input text into these discrete pieces, which are then fed into the model for processing. Tokens allow the model to handle languages of varying structure and complexity, as it can break down the text into manageable units.

Sequences, in this context, refer to the ordered sets of tokens that the model processes at a time. For example, when generating a response or performing a task like language translation, the input is first broken down into tokens, which are arranged in a sequence. The model then analyzes the relationships between these tokens within the sequence to determine patterns, context, and meaning. The length of these sequences can vary, and the performance of an LLM can be affected by how well it can handle longer sequences. Many LLMs have a maximum sequence length, beyond which the input may be truncated or require special techniques, such as attention mechanisms, to effectively process long passages of text.

In the realm of natural language processing, AI training software employs a learning paradigm focused on human preferences to better align pretrained and instruction-tuned generative language models with human values. This process involves the AI training software collecting extensive data, where each data point comprises a context, pairs of continuations of the context (generations), and a pairwise human preference indicating the superior generation. Subsequently, the AI training software learns to generate optimal continuations for a given context based on the collected data.

In some cases, the AI training software may employ reinforcement learning (RL), which is a method of training neural networks that may be used for training LLMs. Similar to human learning, RL trains neural networks through trial and error. Specifically, the neural network produces an output, receives feedback regarding this output, and then learns from the feedback. For instance, when finetuning a language model using reinforcement learning from human feedback (RLHF), the language model generates text and receives a score or reward from a human annotator, which reflects the quality of the text. The AI training software then employs RL to finetune the language model to generate outputs with high scores.

Reinforcement learning proves to be an advantageous and promising learning algorithm for neural networks because it allows learning from non-differentiable signals, which are incompatible with supervised learning. This capability enables the AI training software to learn from arbitrary feedback on a neural network's output. In the case of RLHF, the outputs generated by a language model can be scored according to any predefined principle. The AI training software then uses RL to learn from these scores, regardless of their definition.

Problems addressed via RL are typically structured in a consistent format. Specifically, an agent interacts with an environment, maintaining a state within this environment and producing actions that can alter the current state. As the agent interacts with the environment, it can receive both positive and negative rewards for its actions. The agent's objective is to maximize the rewards received, although not every action is associated with a reward. Rewards may have a long horizon, necessitating several correct, consecutive actions to generate any positive reward. In mathematical terms, RL may be described as a Markov decision process (MDP). An MDP includes states, actions, rewards, transitions, and a policy. States and actions have discrete values, while rewards are real numbers. In an MDP, a policy (referred to herein, interchangeably as a “policy model”) takes a state as input and outputs a probability distribution over possible actions. Given this output, a decision can be made for the action to be taken from a current state, and the transition is then a function that outputs the next state based upon the prior state and chosen action. Using these components, the agent can interact with the environment in an iterative fashion to generate a trained policy.

Depending on how the policies are generated, RLHF can be categorized into on-policy and off-policy settings. In the on-policy setting, the policy model used to generate outputs is the same as the policy model being improved. During this process, a policy model is first initialized from supervised finetuning (SFT). Then, a reward model is obtained based on human or AI feedback. Finally, the policy model samples outputs during training, which are then evaluated using the reward model. The policy model is optimized to improve the expected reward using training objectives such as Proximal Policy Optimization (PPO) and/or Direct Preference Optimization (DPO).

In the context of training methods such as Direct Preference Optimization (DPO), tokens and sequences, described above, play a role in determining how rewards are assigned during the model's learning process. Token-level rewards refer to the rewards that are assigned to individual tokens within a sequence. These rewards are often based on how well a particular token contributes to the overall task performance, such as the accuracy of the predicted token or its alignment with a desired outcome. By assigning rewards at the token level, the model can learn more granular patterns, optimizing the likelihood of selecting better individual tokens in future predictions.

Sequence-level rewards are assigned based on the performance of the entire sequence of tokens. In tasks such as text generation, translation, or summarization, the overall quality and coherence of the generated sequence is important. Sequence-level rewards evaluate the entire output, considering how well the sequence satisfies the task objectives, such as fluency, relevance, or style. In models trained with methods like DPO, sequence-level rewards encourage the model to optimize for global coherence and task fulfillment, rather than focusing narrowly on token-by-token accuracy. Thus, token-level and sequence-level rewards work together to balance the model's learning, with token-level rewards fine-tuning specific predictions and sequence-level rewards ensuring that the model's outputs are meaningful and contextually appropriate on a broader scale.

In some cases, on-policy approaches may rely heavily on policy sampling during training and external rewards, which can incur high costs. In contrast, in the off-policy setting, the outputs and rewards are generated from different models, and the policy model is optimized based on these data instead of its sampled outputs. Therefore, the off-policy setting can offer advantages in terms of cost and efficiency and can be more scalable in scenarios where collecting new outputs and rewards is expensive or impractical.

However, these approaches do not fully address the challenge of providing fine-grained feedback at the token level during preference optimization. Existing methods typically rely on coarse-grained feedback at the sequence level, which can be inefficient for learning and may not capture nuanced preferences at a more granular level. This limitation can lead to suboptimal model performance and slower convergence during training. Additionally, methods that attempt to provide token-level feedback often require separate reward models or high-quality labeled datasets, which can be costly and impractical to obtain for many applications. For example, many of such implementations require a well-trained credit assignment model to determine the rewards or predefined discrete rewards. Training a credit assignment reward model generally requires curating a dataset.

Implementations of this disclosure address problems such as these by providing for preference optimization with token-level regularization. The preference optimization described herein may be referred to as token direct preference optimization (TDPO). For example, some implementations leverage contrastive decoding to prompt an LLM to generate token-level rewards by refining an output in both better and worse directions. The difference in token probabilities between these refinements is used as a token-level reward. This token-level reward is then incorporated as a regularization term in the preference optimization objective, allowing for more fine-grained optimization at the token level rather than just the sequence level.

TDPO may be conceptualized as a revision-based reward labeling that focuses on the credit assignments for each token, ensuring the correct and refined token-level reward. The credit assignment model can be an existing LLM, which may not require any training or dataset curation. To regularize the learned token-level reward in DPO, TDPO may be implemented as the weak-level supervision. In the DPO learning, TDPO not only optimizes over the whole sequence reward but also ensures the correct token-level credit assignments. By generating token-level rewards using the language model itself through contrastive decoding, the approach avoids the need for additional labeled data or separate reward models. The use of token-level rewards may enable better credit assignment and more efficient learning compared to sequence-level rewards alone, while remaining computationally efficient and flexible to integrate with existing preference optimization frameworks.

In some examples of this disclosure, implementations may include or otherwise use one or more AI or ML (collectively, AI/ML) systems having one or more models trained for one or more purposes. Use or inclusion of such AI/ML systems, such as for implementation of certain features or functions, may be turned off by default, where a user, an organization, or both must opt-in to utilize the features or functions that include or otherwise use an AI/ML system. User or organizational consent to use the AI/ML systems or features may be provided in one or more ways, for example, as explicit permission granted by a user prior to using an AI/ML feature, as administrative consent configured by administrator settings, or both. Users for whom such consent is obtained can be notified that they will be interacting with one or more AI/ML systems or features, for example, by an electronic message (e.g., delivered via a chat or email service or presented within a client application or webpage) or by an on-screen prompt, which can be applied on a per-interaction basis. Those users can also be provided with an easy way to withdraw their user consent, for example, using a form or like element provided within a client application, webpage, or on-screen prompt to allow individual users to opt-out of use of the AI/ML systems or features.

To enhance privacy and safety, as well as provide other benefits, the AI/ML processing system may be prevented from using a user's or organization's personal information (e.g., audio, video, chat, screen-sharing, attachments, or other communications-like content (such as poll results, whiteboards, or reactions)) to train any AI/ML models and instead only use the personal information for inference operations of the AI/ML processing system. Instead of using the personal information to train AI/ML models, AI/ML models may be trained using one or more commercially licensed data sets that do not contain the personal information of the user or organization.

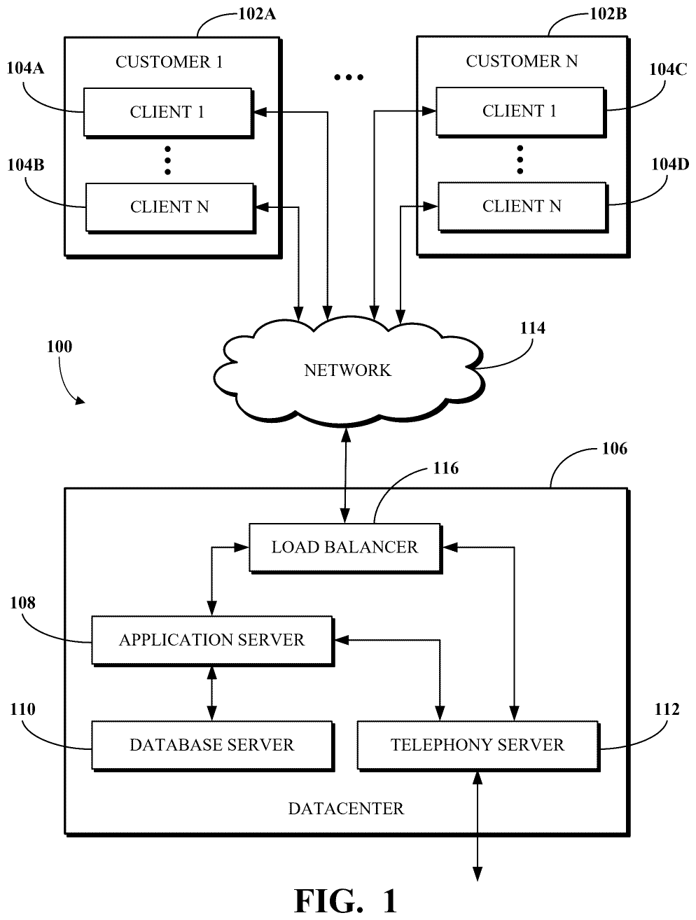

To describe some implementations in greater detail, reference is first made to examples of hardware and software structures used to implement a system for preference optimization with token-level regularization. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customer 102A through customer 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through customer 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through customer 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, one of the client 104A through the client 104B or the application server 108.

The telephony server 112 enables network-based telephony and web communications from and/or to clients of a customer, such as the clients 104A through 104B for the customer 102A or the clients 104C through 104D for the customer 102B. For example, one or more of the clients 104A through 104D may be voice over internet protocol (VOIP)-enabled devices configured to send and receive calls over a network 114. The telephony server 112 includes a session initiation protocol (SIP) zone and a web zone. The SIP zone enables a client of a customer, such as the customer 102A or the customer 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

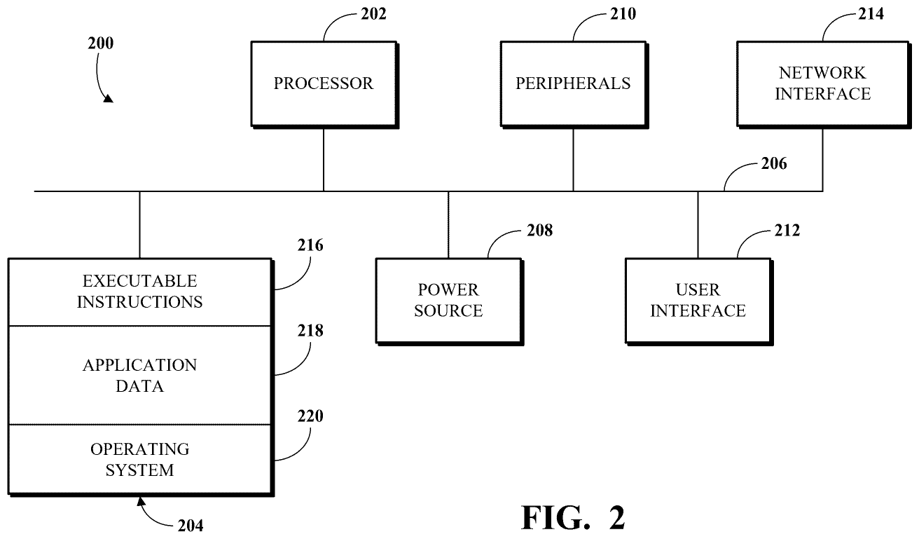

FIG. 2 is a block diagram of an example internal configuration of a computing device 200 of an electronic computing and communications system. In one configuration, the computing device 200 may implement one or more of the client 104A through the client 104B, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

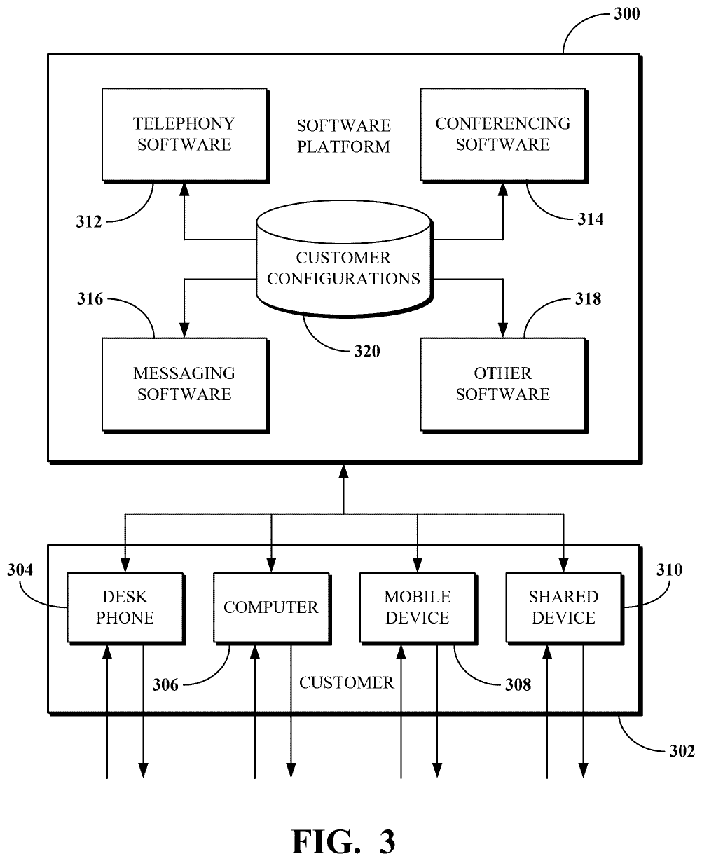

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients-a desk phone, a computer, a mobile device, and a shared device (as shown, a client 304, a client 306, a client 308, and a client 310). The desk phone is a desktop unit configured to at least send and receive calls and includes an input device for receiving a telephone number or extension to dial to and an output device for outputting audio and/or video for a call in progress. The computer is a desktop, laptop, or tablet computer including an input device for receiving some form of user input and an output device for outputting information in an audio and/or visual format. The mobile device is a smartphone, wearable device, or other mobile computing aspect including an input device for receiving some form of user input and an output device for outputting information in an audio and/or visual format. The desk phone, the computer, and the mobile device may generally be considered personal devices configured for use by a single user. The shared device is a desk phone, a computer, a mobile device, or a different device which may instead be configured for use by multiple specified or unspecified users.

Each of the client 304 through the client 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the telephony software 312, the conferencing software 314, the messaging software 316, and the other software 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the client 304 through the client 310 and other telephony-enabled devices, which may be other ones of the client 304 through the client 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, amongst the client 304 through the client 310 be sent or received using the desk phone, a softphone running on the computer, a mobile application running on the mobile device, or using the shared device that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include preference optimization software for LLM training. In some such cases, the telephony software 312, the conferencing software, and/or the messaging software 316 may include the other software 318.

The telephony software 312, the conferencing software 314, the messaging software 316, and the other software 318 may be implemented using one or more servers, for example, of a datacenter such as the datacenter 106 shown in FIG. 1. For example, one or more of the telephony software 312, the conferencing software 314, the messaging software 316, and the other software 318 may be implemented using an application server, a database server, and/or a telephony server, such as the servers 108 through 112 shown in FIG. 1. In another example, one or more of the telephony software 312, the conferencing software 314, the messaging software 316, and the other software 318 may be implemented using servers not shown in FIG. 1, for example, a meeting server, a web server, or another server. In yet another example, one or more of the telephony software 312, the conferencing software 314, the messaging software 316, and the other software 318 may be implemented using one or more of the servers 108 through 112 and one or more other servers. the telephony software 312, the conferencing software 314, the messaging software 316, and the other software 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the telephony software 312, the conferencing software 314, the messaging software 316, and the other software 318 may be combined into a single software application run on clients of the customer, such as one or more of the client 304 through the client 310.

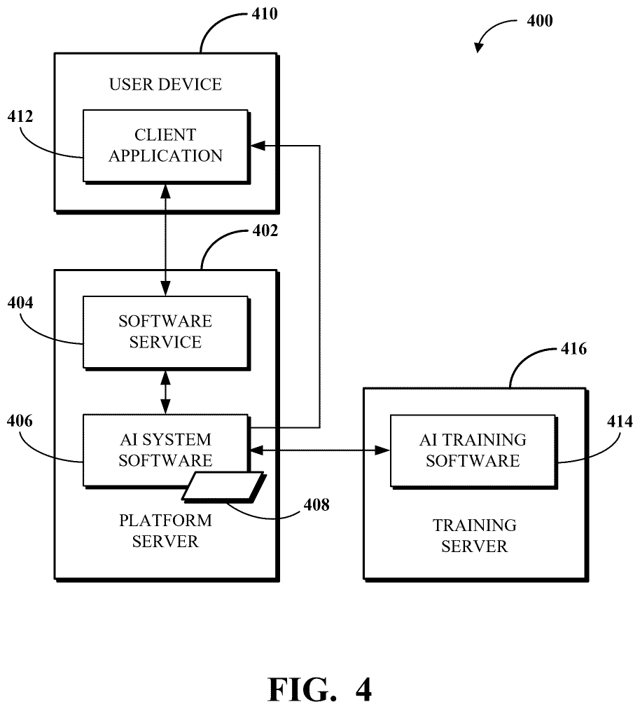

FIG. 4 is a block diagram of an example of an AI system 400 for processing user requests associated with software services of a software platform, such as the software platform 300 shown in FIG. 3. The AI system 400 includes a platform server 402 that implements a software service 404, AI system software 406, and one or more machine learning models 408 such as one or more LLMs. For example, the platform server 402 may include one or more application servers and/or database servers, such as the application server 108 and the database server 110 shown in FIG. 1, used to implement the software service 404, the AI system software 406, and the one or more machine learning models 408. In some cases, the platform server 402 may be or otherwise include multiple servers. In such a case, the software service 404, the AI system software 406, and the one or more machine learning models 408 may be implemented across the multiple servers in one or more ways.

The software service 404 is, includes, or otherwise refers to the components used to run (e.g., execute or interpret) application-level software. For example, the software service 404 may facilitate synchronous or asynchronous communications, such as via one of the software services shown in FIG. 3. In another example, the software service 404 may facilitate functionality directly related, indirectly related, or unrelated to synchronous or asynchronous communications, such as appointment scheduling, event hosting, knowledgebase compilation, digital whiteboarding, workspace reservation, and the like. The software service 404 may thus be one of many software services of the software platform, in which some or all of those other software services may also be implemented by the platform server 402 or by one or more other server devices associated with the software platform.

The software service 404 is accessed by a user device 410, which is a personal or shared computing device configured to run a client application 412 associated with the software service 404. For example, the user device 410 may be one of the clients 304 through 310 shown in FIG. 3. The client application 412 may be a software application installed on the user device 410 and used to access the various software services of the software platform via one or more client-side graphical user interfaces (GUIs). Alternatively, the client application 412 may be a web-based application instantiated based on requests processed in connection with a web browser running at the user device 410. In some implementations, the client application 412 may be omitted, in which case the user device 410 may instead access the software service 404 using other web browser-based approaches or a different software application.

In one non-limiting example, the software service 404 may correspond to conferencing software (e.g., the conferencing software 314 shown in FIG. 3) for facilitating video conferences between users of user devices including the user device 410. The user of the user device 410 connects to the video conference via the client application 412, which interfaces with the software service 404 to cause the user device 410 to join the video conference and thus enable synchronous communications over video and/or audio with the users of the other user devices. For example, the client application 412 may encode a video stream captured at the user device 410 and transmit the encoded video stream for rendering at the other user devices, and it may similarly receive encoded video streams originating at those other user devices and decode same to render the video of the other user device users at the user device 410. The user of the user device 410 may similarly use the client application 412 to access related functionality of the video conference, for example, chat tools for interacting with one or more participants via text, AI tools for summarizing video conference content, and the like.

The software service 404 may receive user requests initiated at the user device 410. The user requests are related to functionality of the software service 404 and correspond to tasks to be actioned by or otherwise on behalf of the software service 404, to generate and transmit responses to the user requests. Non-limiting examples of user requests include requests to summarize video conference content, requests to schedule an appointment or reserve a workspace, requests to classify digital whiteboards by content or creator, and the like. A user request may be initiated at the user device 410 in one or more ways, including, for example, by the user device 410 obtaining input from a user thereof, such as in response to a prompt.

The AI system software 406 obtains such a user request from the software service 404 and causes the one or more machine learning models 408 to process the user request to produce output responsive to the user request. The AI system software 406 then transmits the output to the software service 404 for the software service 404 to present to the user device 410. In particular, the AI system software 406 orchestrates the execution of the one or more machine learning models 408 as part of a model chain by causing the one or more machine learning models 408, in sequence, to perform an inference operation to produce output based on the user request.

In some implementations, the AI system software 406 may cause an execution of one or more machine learning models 408 at the user device 410. For example, the client application 412 may include or otherwise obtain (e.g., download from a source external to the user device 410) executable instructions for implementing a machine learning model at the user device 410. In some such implementations, the one or more machine learning models implemented at the user device 410 may be the first machine learning models of the model chain. Thus, server-side user request traffic may in such cases be avoided or at least limited based on the processing of user requests being handled at the client-side.

The one or more machine learning models 408 may include a trained policy model. The trained policy model may be an LLM trained using AI training software 414 implemented on a training server 416. In some implementations, the training server 416 may be, be similar to, include, or be included in, the platform server 402. In some other implementations, the training server 416 may be distinct from the platform server 402. The training server 416 may refer to any number of server devices and/or server instances. In some implementations, the training server 416 may refer to a federated training system. The training server 416 may include one or more servers, such as the application server 108 and the database server 110 shown in FIG. 1. In some implementations, the training server 416 may implement preference optimization software for training the one or more machine learning models 408.

Reinforcement learning may be described in terms of an MDP. An MDP may be defined by a tuple ( [symbol] , [symbol] , P, R, ρ₀, γ), where [symbol] is the state space, [symbol] is the action space, P(s′|s, a) is the transition distribution, ρ₀(s) is the initial state distribution, R(s, a) is the reward function, and γ∈(0,1) is a discount factor. The goal in RL is to identify a policy π(a|s) that maximizes the expected cumulative discounted rewards which is also known as the return.

For example, given a context x∈ [symbol] , where [symbol] is the finite space of contexts, the AI training software may assume a finite action space [symbol] . A policy model

$$π ∈ {Δ}_{y}^{x}$$

associates to each context x∈ [symbol] a discrete probability distribution π(.|x)∈Δy where Δy is the set of discrete distributions over [symbol] . From a given context x, y, y′˜μ(x) may be two actions generated independently by the reference policy. These may then be presented to human raters or AI raters who express preferences for one of the generations, denoted as y_{w} [symbol] yₗ where y_{w} and yₗ denote the preferred and dispreferred actions amongst {y, y′} respectively. Thus, a preference may be denoted as p(y [symbol] y′|x), the probability of y being preferred to y′ knowing the context x. The probability comes from the randomness of the choice of the human and/or AI that provides the preference.

To facilitate RLHF, AI training software may be provided with a preference dataset

$$𝒟 = {\{ ( {x}^{( i )} , {y}_{w}^{( i )} , {y}_{l}^{( i )} ) \}}_{i = 1}^{N} ,$$

in which y_{w} and yₗ are sampled from a policy model, and y_{w} is favored over yₗ as determined by human or AI annotators. The preference is modeled by a reward model r*(x, y), which assigns a numerical score to each candidate output y based on how well it aligns with the prompt x. There are various ways to model the reward function, among which the Bradley-Terry (BT) model is most commonly used. The BT model assumes that the preference distribution is characterized by the following equation:

$$p ( {y}_{w} ≻ {y}_{l} \vert x ) = \frac{exp ( r * ( x , {y}_{w} ) )}{exp ( r * ( x , {y}_{w} ) ) + exp ( r * ( x , {y}_{l} ) )} .$$

The RLHF process typically consists of two phases: learning the reward model from preference data, followed by using reinforcement learning to optimize a policy model based on this reward. In the first phase, the reward model is trained using maximum likelihood estimation, producing an estimated reward function \hat{r}(x, y). The reward model can be structured to return feedback either at the end of a sequence, where the evaluation is based on the entire output, or at each step of the sequence, where feedback is provided based on intermediate reasoning steps.

Once the reward model is trained, it is used to finetune the policy model by optimizing the following objective:

$${max}_{{π}_{θ}} {𝔼}_{x ∼ 𝒟 , y ∼ {π}_{θ} ( \cdot \vert x )} [ \hat{r} ( x , y ) - β log \frac{{π}_{θ} ( \cdot \vert x )}{{π}_{ref} ( \cdot \vert x )} ] ,$$

where β is a Kullback-Leibler (KL) penalty coefficient to regularize the deviation between the policy model π_{θ} and the reference model π_{ref}, which is usually initialized from the supervised finetuning (SFT) model.

Limitations to the effectiveness of RLHF have emerged from the fact that the sequence-level preference is not grounded in the token level (e.g., from the disparity in sparse vs. dense rewards). To use dense rewards, a well-trained credit assignment model is often used to determine the rewards or predefined discrete rewards. To train a credit assignment reward model, a curated dataset is typically used. However, token-level rewards are implicitly learned during the preference optimization by redistributing the sequence-level rewards and the accuracy of the credit assignments for each token remains relatively unexplored. Therefore, RLHF cannot often be easily adapted to diverse settings and applications and may struggle to capture the fine-grained preferences due to the discrete reward values.

As introduced above, some implementations described herein provide a TDPO technique utilizing contrastive decoding from an LLM to gain the fine-grained token-level credit assignment. For example, TDPO adopts token-level reward labeling and uses the revision prompt to let LLMs label the rewards. Implementations of the revision-based reward labeling described herein focuses on the credit assignments for each token, ensuring the correct and refined token-level reward. For example, the credit assignment model may be an existing LLM (e.g., the LLM corresponding to the policy being optimized). By using implementations described herein, the necessity of training a separate reward model and curating a dataset for that training may be avoided. To regularize the learned token-level reward in DPO, implementations use the TPDO techniques described herein as a weak-level supervision. In this way, the TPDO may optimize a policy over an entire sequence reward and may also ensure the correct token-level credit assignments.

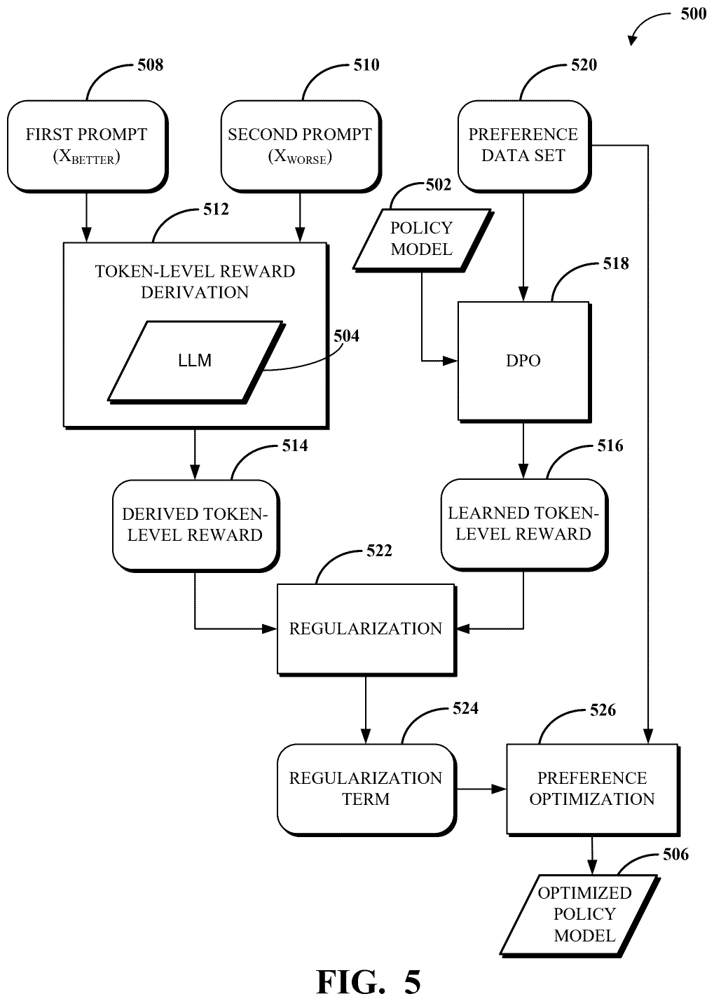

FIG. 5 block schematic diagram of an example 500 of preference optimization with token-level regularization for LLM training functionality of an AI system. The example 500 may be implemented, for example, by a training server such as, for example, the training server 416 shown in FIG. 4. In some implementations, the example 500 may be performed by AI training software such as, for example, the training server 416 shown in FIG. 4. The AI training software may be configured to optimize a policy model 502 corresponding to an LLM 504 to align the policy model 502 with human values, thereby generating an optimized policy model 506.

As described above, some implementations provide for deriving token-level rewards from the LLM 504 (which may be referred to as the reference policy). For example, as shown, the AI training software may provide a first prompt 508 (shown as “x_{better}”) and a second prompt 510 (shown as “x_{worse}”) to the LLM 504 during a token-level reward derivation operation 512. The first and second prompts 508 and 510 may be two contrastive, revision-based prompts, x_{better} and x_{worse}, which aim to refine the current output y towards either positive or negative directions to evaluate token quality. As shown, based on the contrastive, revision-based prompts, the AI training software may determine a derived token-level reward 514. In some implementations, the token-level reward derivation operation may be used to determine any number of derived token-level rewards 514.

In some implementations, a prompting template similar to the prompting template shown below may be used to provide the first and second prompts 508 and 510.

### Prompting Template for Refining an Output

Prompt: Below is a conversation between a user and an AI Assistant.

[User Question]
{instruction}
[The start of Assistant's Answer]
{answer}
[The end of Assistant's Answer]

Please rewrite the Assistant's Answer to make it {direction}. Specifically, the rewritten {direction} answer should closely resemble the original answer but is {direction} in terms of one or multiple of the following aspects: helpfulness, correctness, coherence, verbosity.
IMPORTANT: Please strictly follow the following format: First, choose one or multiple aspects to generate a {direction} answer, such as rewrite the original answer to be {detailed_description}, etc.

[The start of a rewritten {direction} answer]
<provide a { direction} answer here>
[The end of a rewritten {direction} answer]

In the prompting template above, to make the output better, the AI software may set the variable {detailed_description} to “helpful, correct, coherent, concise.” To make the output worse, the AI software may use “unhelpful, incorrect, incoherent, verbose” as the description. Similarly, the variable {direction} can be set to “better” or “worse” to facilitate the contrastive prompting.

For a given token yₜ, the AI software may calculate the token-level reward as follows:

$$\hat{r} ( x , {y}_{< t} , {y}_{t} ) = \frac{{π}_{ref} ( {y}_{t} \vert {x}_{better} , {y}_{< t} ) - {π}_{ref} ( {y}_{t} \vert {x}_{worse} , {y}_{< t} )}{{π}_{ref} ( yt \vert {x}_{better} , {y}_{< t} ) + {π}_{ref} ( yt \vert {x}_{worse} , {y}_{< t} )} ,$$

where π_{ref} represents the reference policy (e.g., the LLM 504). This formulation measures the change of token probability between positive and negative revisions, with the resulting reward value ranging between −1 and 1. Put another way, calculating the token-level reward may include determining a first token probability associated with the first output, determining a second token probability associated with the second output, and determining the derived token-level reward based on the first token probability and the second token probability.

As described above, the regularized token-level preference optimization described herein takes into account the derived token-level rewards 514 as well as learned token-level rewards 516. As shown in FIG. 5, for example, a DPO operation 518 may be performed based on a preference dataset 520 to determine the learned token-level rewards 516.

DPO implicitly learns token-level rewards. In training LLMs, rewards are typically assigned at the end of sequences that can extend to thousands of tokens, whereas not all of them contribute equally to the final reward. Therefore, it is useful for a preference optimization algorithm to accurately distribute sequence-level rewards across individual tokens. The DPO operation 518 implicitly learns a token-level reward function using sequence-level reward supervision. For example, with the token-level reward defined as:

$${r}_{t o k e n}^{*} ( x , {y}_{< t} , {y}_{t} ) = β log \frac{π * ( {y}_{t} \vert x , {y}_{< t} )}{{π}_{ref} ( {y}_{t} \vert x , {y}_{< t} )} ,$$

the sequence-level reward may be computed as:

$${r}_{D P O} ( x , y ) = V * ( x ) + {\sum }_{t = 1}^{T} β log \frac{π * ( {y}_{t} \vert x , {y}_{< t} )}{{π}_{ref} ( {y}_{t} \vert x , {y}_{< t} )} ,$$

where T is the number of tokens in the sequence, π* is the optimal policy, π_{ref} is the reference policy, V* is the value function, β log π*(yₜ|x, y_{<t}) represents an advantage function, and −β log π_{ref} (yₜ|x, y_{<t}) corresponds to a token-level reward from KL divergence. The advantage function and the token-level reward from the KL divergence may be combined as the learned token-level reward.

For a pair of outputs (y_{w}, yₗ), the probability that y_{w} is preferred over yₗ, modeled using the BT model, may be given by:

$$p ( {y}_{w} ≻ {y}_{l} \vert x ) = σ ( {\sum }_{t = 1}^{{T}_{w}} β log \frac{π * ( {y}_{{w}_{t}} \vert x , {y}_{w < t} )}{{π}_{π t r} ( {y}_{{w}_{t}} \vert x , {y}_{{w}_{< 1}} )} - {\sum }_{t = 1}^{{T}_{t}} β log \frac{π * ( {y}_{{l}_{l}} \vert x , {y}_{{l}_{< t}} )}{{π}_{met} ( {y}_{{l}_{t}} \vert x , {y}_{{l}_{< 1}} )} ) ,$$

where V*(x) is cancelled out as y_{w} and yₗ correspond to the same prompt x. By applying maximum likelihood estimation to the preference dataset, the optimal policy model can be optimized by the following loss function:

$${ℒ}_{DPO} = - {𝔼}_{( x , {y}_{w} , {y}_{l} ) ∼ 𝒟} [ log p ( {y}_{w} ≻ {y}_{l} \vert x ) ] ,$$

which resembles the original DPO loss. After performing DPO, the AI software may extract the learned token-level rewards with

$$β log \frac{π * ( {y}_{t} \vert x , {y}_{< t} )}{{π}_{ref} ( {y}_{t} \vert x , {y}_{< t} )} ,$$

where the positive/negative sign indicates positive/negative rewards.

In preference optimization, the goal is to ensure the consistency of pairwise ranking between the model and the preference dataset, as well as to achieve accurate token-level credit assignment. Given that DPO models are trained using sequence-level rewards as supervision, these models are able to effectively capture the pairwise ranking of sequence-level rewards. However, because token-level rewards are implicitly learned by redistributing sequence-level rewards, the accuracy of token-level credit assignment remains unclear. In some cases, LLMs can serve as (dense) token-level reward functions, even without fine-tuning, by employing techniques such as contrastive decoding or opposite prompting. Nonetheless, these methods do not necessarily ensure that the accumulated sequence-level rewards align with the real sequence-level rewards indicated by the preference data. Some implementations combine these two approaches to leverage token-level rewards effectively while preserving sequence-level ranking. Some implementations incorporate token-level rewards as guidance in preference optimization to improve token-level credit assignment, thereby enhancing generalization in preference optimization.

For example, a regularization operation 522 may be performed to determine a regularization term 524. The regularization term 524 may ensure that the token-level reward learned based on the DPO operation 518 aligns with the dense derived token-level reward 514 derived from the LLM 504. To determine the regularization term 524, the AI training software may use r*ₜₒₖₑₙ to denote the learned token-level reward 516 by the optimal policy π*, and \hat{r}ₜₒₖₑₙ to represent the derived token-level reward 514. The regularization term may be defined as follows:

$$reg ( x , y ) = {\sum }_{t = 1}^{T} {r}_{token}^{*} ( x , {y}_{< t} , {y}_{t} ) {\hat{r}}_{t o k e n} ( x , {y}_{< t} , {y}_{t} ) ,$$

which computes the similarity between the learned and derived token-level rewards 514 and 516. The regularization term 524 may be integrated into a sequence-level reward:

$${r}_{seq} ( x , y ) = ( 1 - α ) {r}_{DPO} ( x , y ) + α reg ( x , y ) ,$$

where α is a hyperparameter that controls the strength of regularization. In a manner similar to DPO, the AI software may perform a preference optimization operation 526 based on the preference data set and the regularized sequence-level reward to generate the optimized policy model 506. The preference optimization operation 526 may be performed using a BT model and maximum likelihood estimation to optimize the policy model 502 over the preference dataset 520. The resulting loss function may be given by:

$${ℒ}_{DPO - REG} = \text{} - {𝔼}_{( x , {y}_{w} , {y}_{l} ) ∼ 𝒟}$$

$$[ \text{} σ \text{} ( {\sum }_{t = 1}^{{T}_{w}} {r}_{token} ( x , {y}_{w < t} , {y}_{{w}_{t}} ) - {\sum }_{t = 1}^{{T}_{l}} {r}_{token} ( x , {y}_{l < t} , {y}_{t} ) ) ] ,$$

$$where$$

$${r}_{token} ( x , {y}_{< t} , {y}_{t} ) = β log ( ( 1 - α + α {\hat{r}}_{token} ( x , {y}_{< t} , {y}_{t} ) ) \frac{π ( {y}_{t} \vert x , {y}_{< t} )}{{π}_{ref} ( {y}_{t} \vert x , {y}_{< t} )} ) .$$

The loss function above operates to essentially reweight the tokens in the sequence, where tokens with large \hat{r}ₜₒₖₑₙ are given more weight. Therefore, the regularized loss encourages the policy model 502 to focus more on tokens with potentially large token-level rewards, thereby guiding the preference optimization.

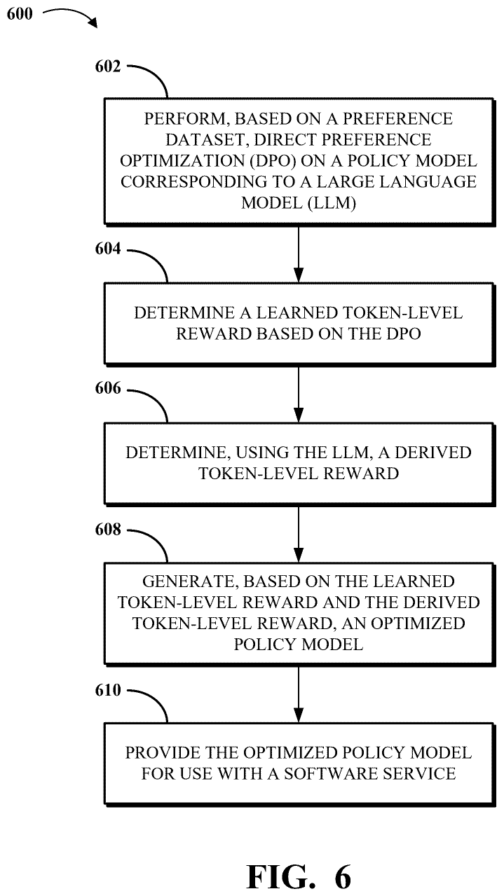

To further describe some implementations in greater detail, reference is next made to examples of techniques which may be performed by or using a system for preference optimization with token-level regularization. FIG. 6 is a flowchart of an example of a technique 600 for preference optimization with token-level regularization. The technique 600 can be executed using computing devices, such as the systems, hardware, software, and/or processes described with respect to FIGS. 1-5. The technique 600 can be performed, for example, by executing a machine-readable program or other computer-executable instructions, such as routines, instructions, programs, or other code. The steps, or operations, of the technique 600, or another technique, method, process, or algorithm described in connection with the implementations disclosed herein can be implemented directly in hardware, firmware, software executed by hardware, circuitry, or a combination thereof.

For simplicity of explanation, the technique 600 is depicted and described herein as a series of steps or operations. However, the steps or operations of the technique 600 can occur in various orders and/or concurrently. Additionally, other steps or operations not presented and described herein may be used. Furthermore, not all illustrated steps or operations may be required to implement a technique in accordance with the disclosed subject matter.

At 602, the technique 600 includes performing, based on a preference dataset, DPO on a policy model corresponding to an LLM. At 604, the technique 600 includes determining a learned token-level reward based on the DPO. In some implementations, determining the learned token-level reward includes determining an advantage function based on the DPO and determining, based on a KL divergence, a token-level reward. The advantage function and the token-level reward may be combined as the learned token-level reward.

At 606, the technique 600 includes determining, using the LLM, a derived token-level reward. In some implementations, the derived token-level reward may be based on a difference in token probabilities between a first output of the LLM and a second output of the LLM. In some implementations, determining the derived token-level reward may include performing a contrastive decoding operation associated with the LLM. Based on the contrastive decoding operation, a first token probability and a second token probability may be determined. The technique 600 may include determining the derived token-level reward based on the first token probability and the second token probability.

For example, determining the derived token-level reward may include generating, based on a first input, a first output of the LLM; generating, based on a second input, a second output of the LLM; and determining the derived token-level reward based on the first output and the second output. In some implementations, determining the derived token-level reward may include obtaining, based on a first revision-based prompt, a first output of the LLM and obtaining, based on a second revision-based prompt, a second output of the LLM. The first revision-based prompt may be a positive prompt and the second revision-based prompt may be a negative prompt.

At 608, the technique 600 includes generating, based on the learned token-level reward and the derived token-level reward, an optimized policy model. At 610, the technique 600 includes providing the optimized policy model for use with a software service.

In some implementations, generating the optimized policy model may include determining a sequence-level reward based on the learned token-level reward and the derived token-level reward and performing a preference optimization operation based on the sequence-level reward. For example, generating the optimized policy model may include determining a regularization term based on the learned token-level reward and the derived token-level reward; and performing, based on the regularization term, a preference optimization operation on the policy model. In some implementations, generating the optimized policy model may include determining a regularization term based on the learned token-level reward and the derived token-level reward; determining a sequence-level reward based on the regularization term; and performing a preference optimization operation based on the sequence-level reward. In some implementations, the sequence-level reward is determined based on the regularization term and a hyperparameter that controls a strength of the regularization term.

In some implementations, generating the optimized policy model may include determining a regularization term based on the learned token-level reward and the derived token-level reward; determining a loss function based on the regularization term; and performing a preference optimization operation based on the loss function. The loss function may be further based on the hyperparameter that controls the strength of the regularization term.

Some implementations include a method, comprising: performing, based on a preference dataset, DPO on a policy model corresponding to an LLM; determining a learned token-level reward based on the DPO; determining, using the LLM, a derived token-level reward; generating, based on the learned token-level reward and the derived token-level reward, an optimized policy model; and providing the optimized policy model for use with a software service.

In some implementations, generating the optimized policy model comprises: determining a regularization term based on the learned token-level reward and the derived token-level reward; and performing, based on the regularization term, a preference optimization operation on the policy model.

In some implementations, generating the optimized policy model comprises: determining a regularization term based on the learned token-level reward and the derived token-level reward; determining a sequence-level reward based on the regularization term; and performing a preference optimization operation based on the sequence-level reward.

In some implementations, generating the optimized policy model comprises: determining a regularization term based on the learned token-level reward and the derived token-level reward; determining a loss function based on the regularization term; and performing a preference optimization operation based on the loss function.

In some implementations, generating the optimized policy model comprises: determining a regularization term based on the learned token-level reward and the derived token-level reward; determining a loss function based on the regularization term and a hyperparameter that controls a strength of the regularization term; and performing a preference optimization operation based on the loss function.

In some implementations, determining the learned token-level reward comprises: determining an advantage function based on the DPO; determining, based on a Kullback-Leibler divergence, a token-level reward; and combining the advantage function with the token-level reward.

In some implementations, determining the derived token-level reward comprises: performing a contrastive decoding operation associated with the LLM.

In some implementations, determining the derived token-level reward comprises: generating, based on a first input, a first output of the LLM; generating, based on a second input, a second output of the LLM; and determining the derived token-level reward based on the first output and the second output.

In some implementations, determining the derived token-level reward comprises: obtaining, based on a first revision-based prompt, a first output of the LLM; obtaining, based on a second revision-based prompt, a second output of the LLM; determining a first token probability associated with the first output; determining a second token probability associated with the second output; and determining the derived token-level reward based on the first token probability and the second token probability.

Some implementations include a non-transitory computer-readable medium storing instructions operable to cause one or more processors to perform operations comprising: performing, based on a preference dataset, DPO on a policy model corresponding to an LLM; determining a learned token-level reward based on the DPO; determining, using the LLM, a derived token-level reward; generating, based on the learned token-level reward and the derived token-level reward, an optimized policy model; and providing the optimized policy model for use with a software service.

In some implementations, the derived token-level reward is based on a difference in token probabilities between a first output of the LLM and a second output of the LLM.

In some implementations, determining the derived token-level reward comprises: performing a contrastive decoding operation associated with the LLM; determining, based on the contrastive decoding operation, a first token probability and a second token probability; and determining the derived token-level reward based on the first token probability and the second token probability.

In some implementations, determining the derived token-level reward comprises: obtaining, based on a positive revision-based prompt, a first output of the LLM; obtaining, based on a negative revision-based prompt, a second output of the LLM; determining a first token probability associated with the first output; determining a second token probability associated with the second output; and determining the derived token-level reward based on the first token probability and the second token probability.

In some implementations, generating the optimized policy model comprises: determining, based on the learned token-level reward and the derived token-level reward, a sequence-level reward; and performing a preference optimization operation based on the sequence-level reward.

In some implementations, generating the optimized policy model comprises: determining a regularization term based on the learned token-level reward and the derived token-level reward; determining, based on the regularization term and a hyperparameter that controls a strength of the regularization term, a sequence-level reward; and performing a preference optimization operation based on the sequence-level reward.

Some implementations include a system, comprising: one or more memories; and one or more processors configured to execute instructions stored in the one or more memories to cause the system to: perform, based on a preference dataset, DPO on a policy model corresponding to an LLM; determine a learned token-level reward based on the DPO; determine, using the LLM, a derived token-level reward; generate, based on the learned token-level reward and the derived token-level reward, an optimized policy model; and provide the optimized policy model for use with a software service.

In some implementations, the derived token-level reward is based on a difference in token probabilities between a first output of the LLM and a second output of the LLM.

In some implementations, to generate the optimized policy model, the one or more processors are configured to execute the instructions to further cause the system to: determine a first probability of a first token associated with a first output of the LLM; determine a second probability of the first token associated with a second output of the LLM; and determine, based on a difference between the first probability and the second probability, the derived token-level reward.

In some implementations, to generate the optimized policy model, the one or more processors are configured to execute the instructions to further cause the system to: determine a regularization term based on the learned token-level reward and the derived token-level reward; determine a loss function based on the regularization term and a hyperparameter that controls a strength of the regularization term; and perform a preference optimization operation based on the loss function.

In some implementations, to determine the learned token-level reward, the one or more processors are configured to execute the instructions to further cause the system to: determine an advantage function based on the DPO; determine, based on a Kullback-Leibler divergence, a token-level reward; and combine the advantage function with the token-level reward.

As used herein, unless explicitly stated otherwise, any term specified in the singular may include its plural version. For example, “a computer that stores data and runs software,” may include a single computer that stores data and runs software or two computers-a first computer that stores data and a second computer that runs software. Also “a computer that stores data and runs software,” may include multiple computers that together stored data and run software. At least one of the multiple computers stores data, and at least one of the multiple computers runs software.

As used herein, the term “computer-readable medium” encompasses one or more computer readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term “memory subsystem” includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing circuitry.

As used herein, processing circuitry includes one or more processors. The one or more processors may be arranged in one or more processing units, for example, a central processing unit (CPU), a graphics processing unit (GPU), or a combination of at least one of a CPU or a GPU.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory subsystem and hardware that is hard-wired into the processing circuitry.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
performing, based on a preference dataset, direct preference optimization (DPO) on a policy model corresponding to a large language model (LLM);
determining a learned token-level reward based on the DPO;
determining, using the LLM, a derived token-level reward;
generating, based on the learned token-level reward and the derived token-level reward, an optimized policy model; and
providing the optimized policy model for use with a software service.

2. The method of claim 1, wherein generating the optimized policy model comprises:
determining a regularization term based on the learned token-level reward and the derived token-level reward; and
performing, based on the regularization term, a preference optimization operation on the policy model.

3. The method of claim 1, wherein generating the optimized policy model comprises:
determining a regularization term based on the learned token-level reward and the derived token-level reward;
determining a sequence-level reward based on the regularization term; and
performing a preference optimization operation based on the sequence-level reward.

4. The method of claim 1, wherein generating the optimized policy model comprises:
determining a regularization term based on the learned token-level reward and the derived token-level reward;
determining a loss function based on the regularization term; and

5. The method of claim 1, wherein generating the optimized policy model comprises:
determining a regularization term based on the learned token-level reward and the derived token-level reward;
determining a loss function based on the regularization term and a hyperparameter that controls a strength of the regularization term; and
performing a preference optimization operation based on the loss function.

6. The method of claim 1, wherein determining the learned token-level reward comprises:
determining an advantage function based on the DPO;
determining, based on a Kullback-Leibler divergence, a token-level reward; and
combining the advantage function with the token-level reward.

7. The method of claim 1, wherein determining the derived token-level reward comprises:
performing a contrastive decoding operation associated with the LLM.

8. The method of claim 1, wherein determining the derived token-level reward comprises:
generating, based on a first input, a first output of the LLM;
generating, based on a second input, a second output of the LLM; and
determining the derived token-level reward based on the first output and the second output.

9. The method of claim 1, wherein determining the derived token-level reward comprises:
obtaining, based on a first revision-based prompt, a first output of the LLM;
obtaining, based on a second revision-based prompt, a second output of the LLM;
determining the derived token-level reward based on the first token probability and the second token probability.

10. A non-transitory computer-readable medium storing instructions operable to cause one or more processors to perform operations comprising:
performing, based on a preference dataset, direct preference optimization (DPO) on a policy model corresponding to a large language model (LLM);
determining a learned token-level reward based on the DPO;
determining, using the LLM, a derived token-level reward;
generating, based on the learned token-level reward and the derived token-level reward, an optimized policy model; and
providing the optimized policy model for use with a software service.

11. The non-transitory computer-readable medium of claim 10, wherein the derived token-level reward is based on a difference in token probabilities between a first output of the LLM and a second output of the LLM.

12. The non-transitory computer-readable medium of claim 10, determining the derived token-level reward comprises:
performing a contrastive decoding operation associated with the LLM;
determining, based on the contrastive decoding operation, a first token probability and a second token probability; and
determining the derived token-level reward based on the first token probability and the second token probability.

13. The non-transitory computer-readable medium of claim 10, wherein determining the derived token-level reward comprises:
obtaining, based on a positive revision-based prompt, a first output of the LLM;
determining the derived token-level reward based on the first token probability and the second token probability.

14. The non-transitory computer-readable medium of claim 10, wherein generating the optimized policy model comprises:
determining, based on the learned token-level reward and the derived token-level reward, a sequence-level reward; and
performing a preference optimization operation based on the sequence-level reward.

15. The non-transitory computer-readable medium of claim 10, wherein generating the optimized policy model comprises:
determining a regularization term based on the learned token-level reward and the derived token-level reward;
determining, based on the regularization term and a hyperparameter that controls a strength of the regularization term, a sequence-level reward; and
performing a preference optimization operation based on the sequence-level reward.

16. A system, comprising:
one or more memories; and
one or more processors configured to execute instructions stored in the one or more memories to cause the system to:
perform, based on a preference dataset, direct preference optimization (DPO) on a policy model corresponding to a large language model (LLM);
determine a learned token-level reward based on the DPO;
determine, using the LLM, a derived token-level reward;
generate, based on the learned token-level reward and the derived token-level reward, an optimized policy model; and
provide the optimized policy model for use with a software service.

17. The system of claim 16, wherein the derived token-level reward is based on a difference in token probabilities between a first output of the LLM and a second output of the LLM.

18. The system of claim 16, wherein, to generate the optimized policy model, the one or more processors are configured to execute the instructions to further cause the system to:
determine a first probability of a first token associated with a first output of the LLM;
determine a second probability of the first token associated with a second output of the LLM; and
determine, based on a difference between the first probability and the second probability, the derived token-level reward.

19. The system of claim 16, wherein, to generate the optimized policy model, the one or more processors are configured to execute the instructions to further cause the system to:
determine a regularization term based on the learned token-level reward and the derived token-level reward;
determine a loss function based on the regularization term and a hyperparameter that controls a strength of the regularization term; and
perform a preference optimization operation based on the loss function.

20. The system of claim 16, wherein, to determine the learned token-level reward, the one or more processors are configured to execute the instructions to further cause the system to:
determine an advantage function based on the DPO;
determine, based on a Kullback-Leibler divergence, a token-level reward; and
combine the advantage function with the token-level reward.
